(19) United States
(12) Patent Application Publication
(10) Pub. No.: US 2012/0178305 A1
(43) Pub. Date: Jul. 12, 2012

(54) POWER ADAPTER HAVING A ROTATABLE PLUG

(76) Inventor: SHEN-LIANG CHEN, New Taipei City (TW)

(21) Appl. No.: 13/004,672

(22) Filed: Jan. 11, 2011

(51) Int. Cl. H01R 24/00

(52) U.S. Cl. 439/660

(57) ABSTRACT

The power adapter having a rotatable plug has a body and a plug. The body has a mounting seat and two conducting terminals. The mounting seat protrudes from the body. The conducting terminals are mounted respectively on the mounting seat. The plug is mounted detachably and rotatably on the body and has two prongs, two contact pieces and a mounting recess. The contact pieces are mounted inside the plug, fixed respectively to the prongs and respectively contact the conducting terminals of the body. The mounting recess is formed in the plug and holds the mounting set of the body inside. Therefore, the plug can be selectively oriented to adjust the prongs to a suitable orientation so the body does not block receptacles. Furthermore, the plug is small in size so the power adapter can be plugged in a receptacle stably and electrical safety is enhanced.

### BACKGROUND OF THE INVENTION

1. Field of the Invention

The present invention relates to a power adapter, and more particularly to a power adapter having a rotatable plug.

2. Description of the Prior Arts

A conventional power adapter has a body having a transformer mounted therein and two prongs fixedly mounted thereon. The transformer and the prongs are electrically connected with each other. The prongs are plugged in a receptacle of a power outlet to deliver electrical power to an electrical device. However, the body in which the transformer is mounted is relatively bulky and the prongs are fixed and are not adjustable relative to the body. Therefore, the body may block other receptacles of the power socket and limit the other receptacles of the power outlet in use.

With reference to FIG. 10, another conventional power adapter has a body 40 and a plug 50. The plug 50 is mounted detachably and rotatably on the body 40 and has two prongs 51. The plug 50 can be selectively oriented to adjust the prongs 51 to a suitable orientation so the body 40 does not block sockets and limit the sockets in use. However, both of the body 40 and the plug 50 are relatively bulky. When the prongs 51 of the plug 50 are plugged in a power outlet 60 that is disposed vertically, the plug 50 and the body 40 have a long moment arm about the prongs 51 and the prongs 51 bear a heavy weight. Therefore, the power adapter may escape from the power outlet 60 and electrical safety may be reduced.

To overcome the shortcomings, the present invention provides a power adapter having a rotatable plug to mitigate or obviate the aforementioned problems.

### SUMMARY OF THE INVENTION

The main object of the present invention is to provide a power adapter having a rotatable plug being small in size to enhance electrical safety.

To achieve the foregoing objective, the power adapter having a rotatable plug in accordance with the present invention comprises a body and a plug. The body has a bottom surface, a mounting seat and two conducting terminals. The mounting seat protrudes from the bottom surface of the body. The conducting terminals are mounted respectively on the mounting seat. The plug is mounted detachably and rotatably on the body and has two prongs, two contact pieces and a mounting recess. The prongs protrude out of the plug. The contact pieces are mounted inside the plug, fixed respectively to the prongs and respectively contact the conducting terminals of the body. The mounting recess is formed in a top surface of the plug and holds the mounting set of the body inside. Therefore, the plug can be selectively oriented to adjust the prongs to a suitable orientation relative to the body so the body does not block receptacles. Further, the plug is small in size so the power adapter can be plugged in a receptacle stably and electrical safety is enhanced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a power adapter having a rotatable plug in accordance with the present invention;

FIG. 2 is a partially enlarged exploded perspective view of the power adapter in FIG. 1;

FIG. 3 is a partially enlarged side view in partial section of the power adapter in FIG. 1;

FIGS. 4 and 5 are enlarged operational top views of two conducting rods, two conducting terminals and a plug of the power adapter in FIG. 1, showing a plug being rotated;

FIG. 6 is a perspective view of the conducting rods, the conducting terminals and the plug of the power adapter in FIG. 1;

FIG. 7 is an enlarged top view of the conducting rods, the conducting terminals and the plug of the power adapter in FIG. 1, showing the plug being mounted in a different orientation;

FIG. 8 is a partially enlarged bottom view of the power adapter in FIG. 1 showing the plug being oriented in different orientations;

FIG. 9 is a side view of the power adapter in FIG. 1 being plugged in a power outlet; and

FIG. 10 is a side view of a conventional power adapter in accordance with the prior art being plugged in a power outlet.

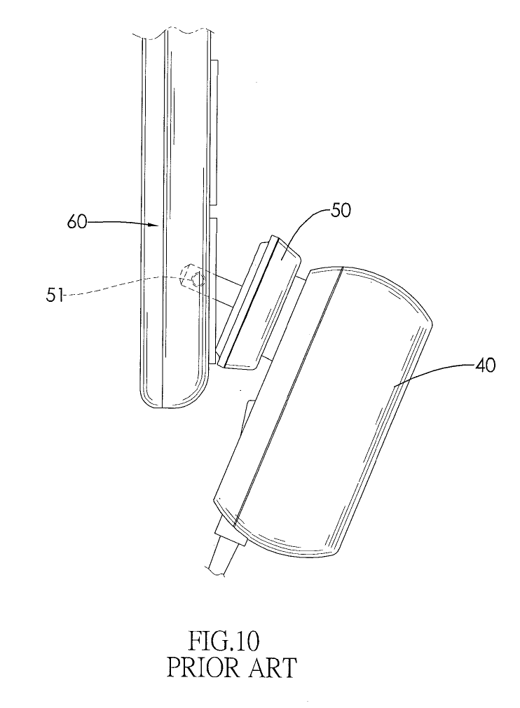

### DETAILED DESCRIPTION OF THE PREFERRED EMBODIMENTS

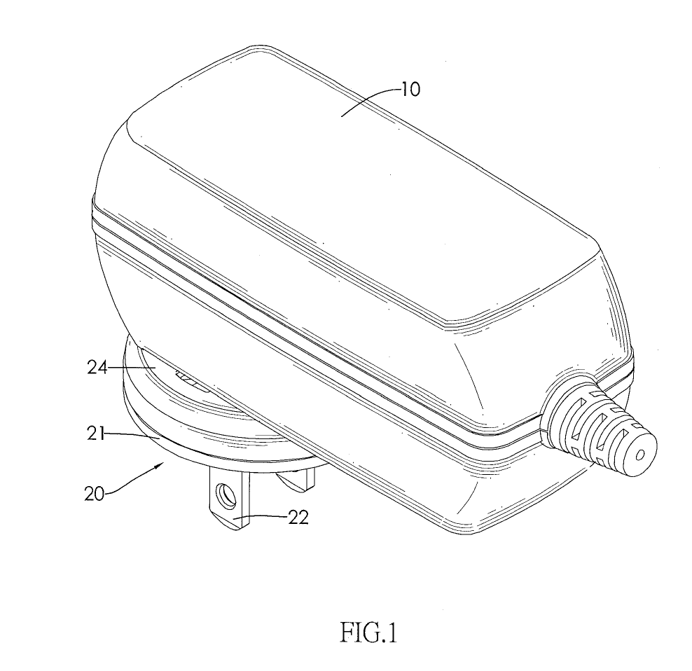

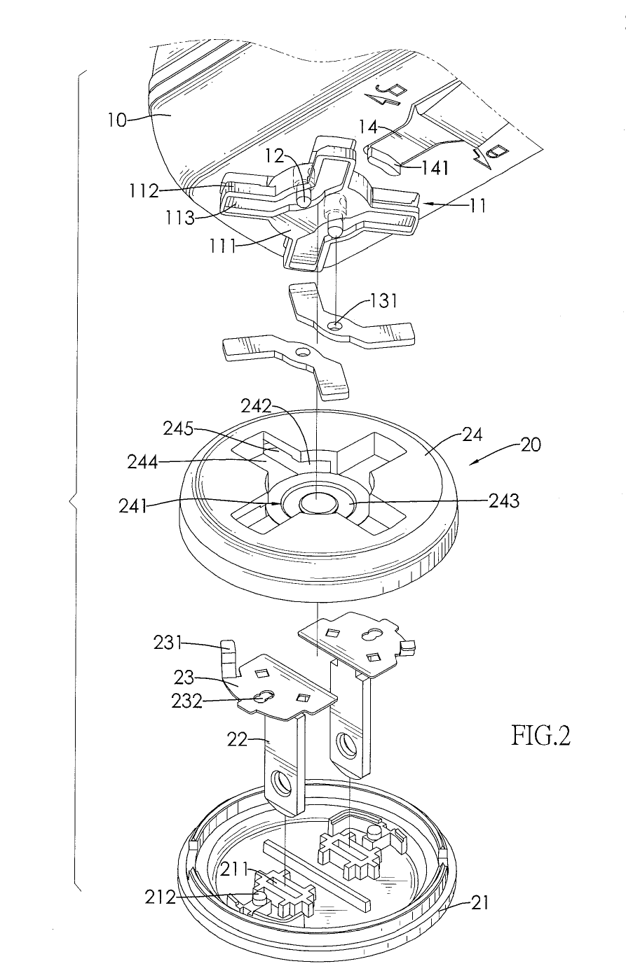

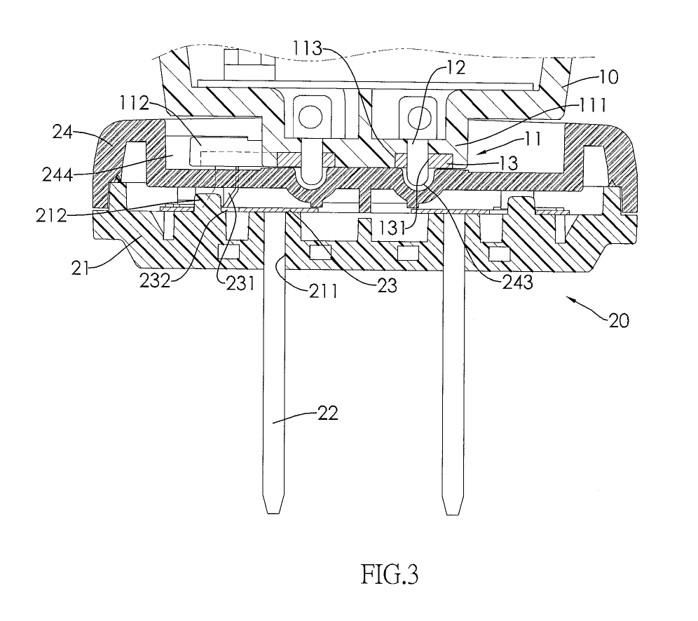

With reference to FIGS. 1 to 3, a power adapter having a rotatable plug in accordance with the present invention comprises a body 10 and a plug 20.

The body 10 is hollow and has a transformer, a bottom surface, a mounting set 11, two conducting rods 12, two conducting terminals 13 and a resilient tongue 14. The transformer is mounted inside the body. The mounting seat 11 protrudes from the bottom surface of the body 10, is X-shaped and has a bottom surface, a central plate 111, four wings 112 and two grooves 113. The wings 112 protrude radially from the central plate 111, and a gap is formed between each wing 112 and the bottom surface of the body 10. The grooves 113 are formed separately in the bottom surface of the mounting seat 11. The grooves 113 are positioned respectively at two opposite sides of the central plate 111 and each groove 113 is defined in and extends to two adjacent wings 112 and has a groove surface. The conducting rods 12 protrude respectively from the groove surfaces of the grooves 113 of the mounting seat 11 and are electrically connected to the transformer. The conducting terminals 13 are mounted respectively in the grooves 113 of the mounting seat 11 and each conducting terminal 13 has a first end, a second end and a contact hole 131. The contact hole 131 is mounted around and contacts a corresponding conducting rod 12, and the conducting rods 12 protrude respectively out of the contact holes 131 in the conducting terminals 13. The resilient tongue 14 is formed on the bottom surface of the body 10 and has a free end and a locking block 141. The free end is near the mounting set 11. The locking block 141 protrudes from the free end.

The plug 20 is mounted detachably and rotatably on the body 10 and has a base 21, two prongs 22, two contact pieces 23 and a cover 24. The base 21 has an inner surface, an outer surface, two slots 211 and two protrusions 212. The slots 211 are formed through the base 21. The protrusions 212 protrude from the inner surface of the base and are respectively adjacent to the slots 211. The prongs 22 are mounted respectively through the slots 211 of the base 21 and are parallel to each other, and each prong 22 has an inner end and an outer end. The inner ends are disposed in the slots 211 of the base 21. The outer ends protrude out of the outer surface of the base 21. The contact pieces 23 are mounted inside the base 21 and fixed respectively to the inner ends of the prongs 22 and respectively contact the conducting terminals 13 of the body 10. Each contact piece 23 has a protruding arm 231 and a connecting hole 232. The protruding arm 231 protrudes from the contact piece 23 and extends upwardly and contacts a corresponding conducting terminal 13 of the body 10. The connecting hole 232 is formed through the contact piece 23 and holds a corresponding protrusion 212 of the base 21 inside to mount the prongs 22 on the base 21 securely. The cover 24 corresponds to and covers the base 21 so as to form a chamber between the cover 24 and base 21. The cover 24 has an outer surface and a mounting recess 241. The mounting recess 241 is formed in the outer surface of the cover 24, is X-shaped, corresponds to and holds the mounting set 11 of the body 10 inside and has a central recess 242, an annual recess 243, four channels 244 and four notches 245. The central recess 242 holds the central plate 111 of the mounting set 11 of the body 10 inside and has a recessed surface. The annual recess 243 is formed concentrically in the recessed surface of the central recess 242 and the conducting rods 12 of the body 10 are mounted slidably in and along the annual recess 243. The channels 244 are formed radially from the central recess 242, each channel 244 has a sidewall and one of the channels 244 holds the locking block 141 of the resilient tongue 14 inside. The notches 245 are formed respectively through sidewalls of the channels 244 and allow the wings 112 of the mounting set 11 of the body 10 received in the channels 244 to pass respectively through the notches 245 and to be disposed in the chamber between the base 21 and cover 24.

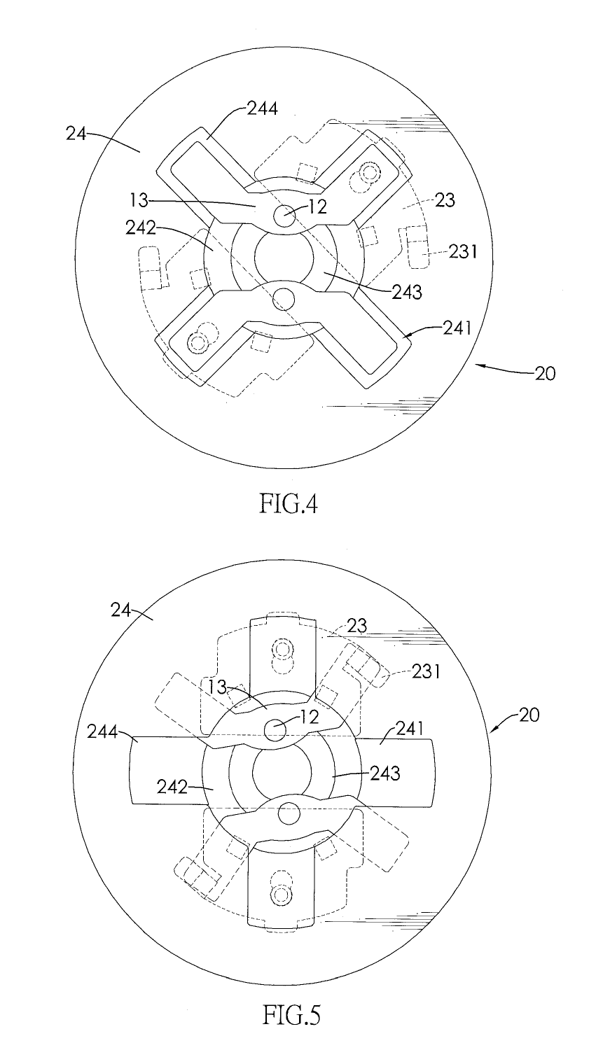

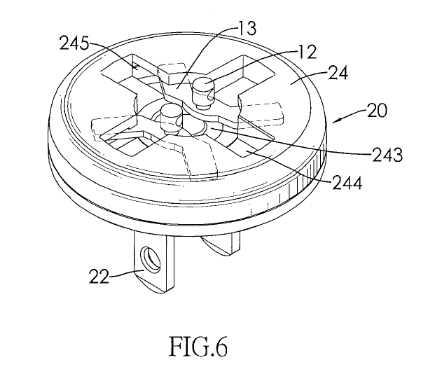

With further reference to FIG. 4, when the plug 20 is operated to be assembled with the body 10, the central plate 111 of the mounting set 11 is put into the central recess 242 of the mounting recess 241 and the wings 112 of the mounting set 11 are put respectively into the channels 244 of the mounting recess 241. Meanwhile, the locking block 141 of the resilient tongue 14 is pressed by the outer surface of the cover 24. With further reference to FIGS. 5 and 6, the plug 20 is then rotated relative to the body 10 to make the conducting rods 12 slide along the annual recess 243 of the mounting recess 241 and the wings 112 of the mounting set 11 pass through the notches 245 of the mounting recess 241 to be disposed in the chamber between the base 21 and cover 24. The plug 20 is rotated until the locking block 141 of the resilient tongue 14 is locked in one of the channels 244 of the mounting recess 241. Besides, the protruding arms 231 of the contact pieces 23 respectively contact the first ends of the conducting terminals 13. Thus, the body 10 and the plug 20 are assembled so the prongs 22 of the plug 20 can be plugged in a receptacle of a power outlet to deliver electric power to an electrical device.

The plug 20 can be disassembled from the body 10 by performing the foregoing procedures in reverse. The resilient tongue 14 is pressed so that the locking block 141 of the resilient tongue 14 departs from the corresponding channel 244 of the mounting recess 241 and the plug 20 can be rotated relative to the body 10 in reverse to make the wings 112 of the mounting set 11 pass through the notches 245 of the mounting recess 241 and into the channels 244 of the mounting recess 241. Thus, the plug 20 can be detached from the body 10.

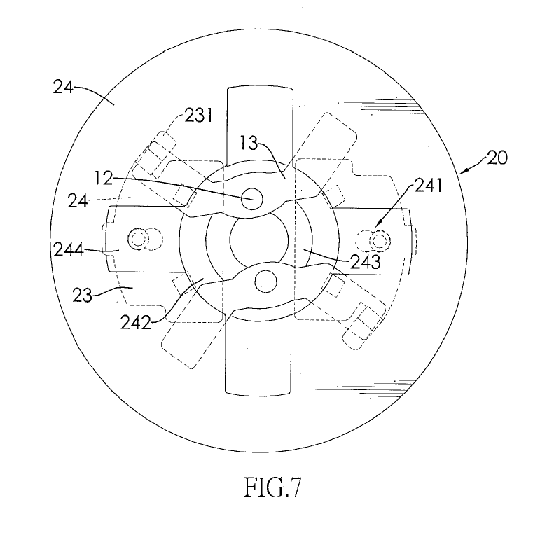

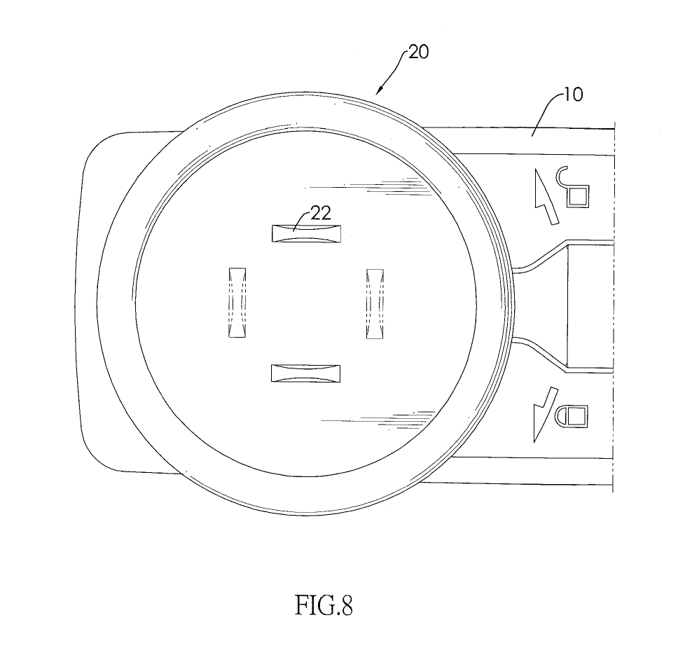

With reference to FIG. 7, when the plug 20 is operated to be assembled with the body 10, the plug 20 can be adjusted in a different orientation by putting the wings 112 of the mounting set 11 into different channels 244 of the mounting recess 241 and contacting the protruding arms 231 of the contact pieces 23 respectively with the second ends of the conducting terminals 13. The power adapter in accordance with the present invention provides the prongs 22 of the plug 20 to be oriented in two orientations relative to the body 10 as shown in FIG. 8. Therefore, the prongs 22 of the plug 20 can be selectively adjusted to a suitable orientation, the body 10 will not obstruct other receptacles of the same power outlet and the receptacles can be fully utilized.

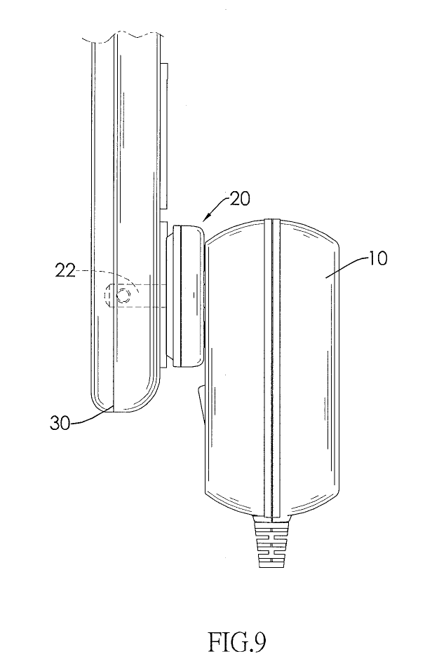

With further reference to FIG. 9, with the combination of the mounting set 11 of the body 10 and the mounting recess 241 of the plug 20, the plug 20 can be designed to be smaller in size as compared with a conventional plug. When the prongs 22 of the plug 20 are plugged in a power outlet 30 that is disposed vertically, the plug 20 and body 10 have a short moment arm about the prongs 22 of the plug 20 and the prongs 22 bear a lighter weight. Therefore, the power adapter in accordance with the present invention can be plugged in the power outlet 30 stably to insure electrical safety.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A power adapter comprising:
a body having
a bottom surface;
a mounting set protruding from the bottom surface of the body; and
two conducting terminals mounted respectively on the mounting seat; and
a plug mounted detachably and rotatably on the body and having
two prongs protruding out of the plug;
two contact pieces mounted inside the plug, fixed respectively to the prongs and respectively contact the conducting terminals of the body; and
a mounting recess formed in the plug and corresponding to and holding the mounting set of the body inside.

2. The power adapter as claimed in claim 1, wherein
the mounting set of the body is X-shaped and has
a bottom surface;
a central plate;
four wings protruding radially from the central plate, and a gap formed between each wing and the bottom surface of the body; and
two grooves formed separately in the bottom surface of the mounting seat, positioned respectively at two opposite sides of the central plate, each groove defined in and extending to two adjacent wings, and the conducting terminals respectively mounted in the grooves; and
the mounting recess of the plug is X-shaped and has
a central recess holding the central plate of the mounting set of the body inside;
four channels formed radially from the central recess and each channel having a sidewall; and
four notches formed respectively through sidewalls of the channels and allowing the wings of the mounting set of the body received in the channels to pass respectively through the notches to be disposed inside the plug.

3. The power adapter as claimed in claim 1, wherein each contact piece has a protruding arm protruding from the contact piece and contacting one of the conducting terminals of the body.

4. The power adapter as claimed in claim 2, wherein each contact piece has a protruding arm protruding from the contact piece and contacting one of the conducting terminals of the body.

5. The power adapter as claimed in claim 2, wherein the body further has a resilient tongue formed on the bottom surface of the body and having
a free end being near the mounting set; and
a locking block protruding from the free end and selectively locked in one of the channels of the mounting recess of the plug.

6. The power adapter as claimed in claim 4, wherein the body further has a resilient tongue formed on the bottom surface of the body and having
a free end being near the mounting set; and
a locking block protruding from the free end and selectively locked in one of the channels of the mounting recess of the plug.

7. The power adapter as claimed in claim 1, wherein
the plug further has
a base having
an outer surface; and
two slots formed through the base; and
a cover corresponding to and covering the base and having an outer surface and the mounting recess formed in the outer surface of the cover; and
the prongs of the plug are mounted respectively through the slots, and each prong has
an inner end disposed in the slot and fixed to the contact piece; and
an outer end protruding out of the outer surface of the base.

8. The power adapter as claimed in claim 2, wherein
the plug further has
a base having
an outer surface; and
two slots formed through the base; and
a cover corresponding to and covering the base and having an outer surface and the mounting recess formed in the outer surface of the cover; and
the prongs of the plug are mounted respectively through the slots, and each prong has
an inner end disposed in the slot and fixed to the contact piece; and
an outer end protruding out of the outer surface of the base.

9. The power adapter as claimed in claim 3, wherein
the plug further has
a base having
an outer surface; and
two slots formed through the base; and
a cover corresponding to and covering the base and having an outer surface and the mounting recess formed in the outer surface of the cover; and
the prongs of the plug are mounted respectively through the slots, and each prong has
an inner end disposed in the slot and fixed to the contact piece; and
an outer end protruding out of the outer surface of the base.

10. The power adapter as claimed in claim 4, wherein
the plug further has
a base having
an outer surface; and
two slots formed through the base; and
a cover corresponding to and covering the base and having an outer surface and the mounting recess formed in the outer surface of the cover; and
the prongs of the plug are mounted respectively through the slots, and each prong has
an inner end disposed in the slot and fixed to the contact piece; and
an outer end protruding out of the outer surface of the base.

11. The power adapter as claimed in claim 5, wherein
the plug further has
a base having
an outer surface; and
two slots formed through the base; and
a cover corresponding to and covering the base and having an outer surface and the mounting recess formed in the outer surface of the cover; and
the prongs of the plug are mounted respectively through the slots, and each prong has
an inner end disposed in the slot and fixed to the contact piece; and
an outer end protruding out of the outer surface of the base.

12. The power adapter as claimed in claim 6, wherein
the plug further has
a base having
an outer surface; and
two slots formed through the base; and
a cover corresponding to and covering the base and having an outer surface and the mounting recess formed in the outer surface of the cover; and
the prongs of the plug are mounted respectively through the slots, and each prong has
an inner end disposed in the slot and fixed to the contact piece; and
an outer end protruding out of the outer surface of the base.

13. The power adapter as claimed in claim 1, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.

14. The power adapter as claimed in claim 2, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.

15. The power adapter as claimed in claim 3, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.

16. The power adapter as claimed in claim 4, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.

17. The power adapter as claimed in claim 5, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.

18. The power adapter as claimed in claim 6, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.

19. The power adapter as claimed in claim 7, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.

20. The power adapter as claimed in claim 12, wherein
the mounting set of the body has two conducting rods protruding respectively from the bottom surface of the mounting set;
each conducting terminal of the body has a contact hole mounted around and contacting one of the conducting rods, and the conducting rods protrude respectively out of the contact holes; and
the mounting recess of the plug has an annual recess formed centrally in the mounting recess and the conducting rods of the mounting set of the body are mounted slidably in and along the annual recess.
